(19) United States
(12) Patent Application Publication
(10) Pub. No.: US 2022/0350068 A1
(43) Pub. Date: Nov. 3, 2022

(54) LIGHT SOURCE MODULE AND METHOD FOR MANUFACTURING THE SAME, AND DISPLAY MODULE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Peng Zhong, Beijing (CN); Fei Liang, Beijing (CN); Xiuyun Chen, Beijing (CN); Lingyu Sun, Beijing (CN); Jingjun Du, Beijing (CN); Tingxiu Hou, Beijing (CN); Chaoyue Zhao, Beijing (CN); Jian Zhao, Beijing (CN); Yongkang Xiao, Beijing (CN)

(21) Appl. No.: 17/310,891

(22) PCT Filed: Nov. 18, 2020
(86) PCT No.: PCT/CN2020/129860

§ 371 Date: Aug. 27, 2021

(51) Int. Cl. F21V 8/00

(52) U.S. Cl. CPC G02B 6/005

(57) ABSTRACT

A light source module and method for manufacturing the same, and a display module, and the light source module includes a light source; a light guide structure; an optical control layer arranged on the first surface of the light guide structure and a plurality of optical structures arranged at intervals at least in a first direction, and the first direction is perpendicular to the light incident surface, each of the plurality of optical structures includes a groove in the optical control layer, and the groove forms an opening in the third surface, each of the plurality of optical structures includes a first optical surface, a second optical surface, a third optical surface, and a fourth optical surface, and the first optical surface, the second optical surface, the third optical surface, and the fourth optical surface are sequentially away from the light incident surface in the first direction.

### CROSS REFERENCE TO RELATED APPLICATION(S)

This application is a Section 371 National Stage Application of International Application No. PCT/CN2020/129860, filed on Nov. 18, 2020, which is incorporated by reference herein in its entirety.

### TECHNICAL FIELD

The present disclosure relates to a field of display technology, and in particular to a light source module and method for manufacturing the same, and a display module.

### BACKGROUND

Compared with a transmissive display device, a reflective display device has softer images and lower power consumption. For example, the reflective display device can obtain better display effects outdoors. Therefore, the reflective display device is more and more popular in fields such as e-readers and public displays. The reflective display device is greatly affected by external environment light, and when the external environment light is insufficient, a display effect of the reflective display device is reduced.

### SUMMARY

The present disclosure provides a light source module, and the light source module includes a light source; a light guide structure including a light incident surface and a first surface, wherein light emitted by the light source enters the light guide structure through the light incident surface; an optical control layer arranged on the first surface of the light guide structure, wherein the optical control layer includes an optical control layer body, a third surface away from the light guide structure, and a fourth surface facing the light guide structure; and a plurality of optical structures arranged in the optical control layer, wherein the plurality of optical structures are configured to adjust the light incident on the plurality of optical structures, wherein the plurality of optical structures are arranged at intervals at least in a first direction, and the first direction is perpendicular to the light incident surface, each of the plurality of optical structures includes a groove in the optical control layer, and the groove forms an opening in the third surface, each of the plurality of optical structures includes a first optical surface, a second optical surface, a third optical surface, and a fourth optical surface, and each of the first optical surface, the second optical surface, the third optical surface, and the fourth optical surface is spaced apart from the fourth surface, and the first optical surface, the second optical surface, the third optical surface, and the fourth optical surface are sequentially away from the light incident surface in the first direction, and the first optical surface and the second optical surface gradually move closer in a direction toward the light guide structure, the second optical surface and the third optical surface gradually move closer in a direction away from the light guide structure, and the third optical surface and the fourth optical surface gradually move closer in a direction toward the light guide structure, wherein the groove is filled with a low refractive index material, and a refractive index of the low refractive index material is less than a refractive index of the optical control layer body; or the groove is filled with air, the refractive index of the optical control layer body is greater than a refractive index of air.

In some embodiments, the first optical surface and the second optical surface converge at a first intersection line, and the second optical surface and the third optical surface converge at a second intersection line, the third optical surface and the fourth optical surface converge at a third intersection line, wherein the first intersection line, the second intersection line, and the third intersection line are parallel to each other, and each of the first intersection line, the second intersection line and the third intersection line is parallel to the third surface, and each of the first intersection line, the second intersection line, and the third intersection line is located on a side of the third surface close to the fourth surface.

In some embodiments, 0°<α1, α2, α3, α4<90°, H1>H3>H2>0, M3>M2>M1>0, wherein α1 is an included angle between the first optical surface and a plane where the third surface is located, α2 is an included angle between the first optical surface and the second optical surface, and α3 is an included angle between the second optical surface and the third optical surface, and α4 is an included angle between the third optical surface and the fourth optical surface, H1 is a distance between the first intersection line and the plane where the third surface is located, H2 is a distance between the second intersection line and the plane where the third surface is located, and H3 is a distance between the third intersection line and the plane where the third surface is located, wherein the first optical surface and the third surface converge at a fourth intersection line, the fourth optical surface and the third surface converge at a fifth intersection line, and M1 is a distance between the second intersection line and the fifth intersection line in the first direction, M2 is a distance between the first intersection line and the fifth intersection line in the first direction, and M3 is a distance between the fourth intersection line and the fifth intersection line.

In some embodiments, each of the first intersection line, the second intersection line, the third intersection line, the fourth intersection line, and the fifth intersection line is perpendicular to the first direction.

In some embodiments, a refractive index of the light guide structure is substantially equal to the refractive index of the optical control layer body.

In some embodiments, the first optical surface is a curved surface that is recessed toward inside of each of the plurality of optical structures, and each of the second optical surface, the third optical surface and the fourth optical surface is a plane.

In some embodiments, the light source module includes at least a first distribution area and a second distribution area, and the first distribution area is closer to the light incident surface than the second distribution area in the first direction, and wherein a depth of an optical structure in the plurality of optical structures located in the first distribution area is less than a depth of an optical structure in the plurality of optical structures located in the second distribution area, and the depth of the optical structure is a dimension of the optical structure in a second direction, and the second direction is perpendicular to the third surface.

In some embodiments, the light source module includes at least a first distribution area and a second distribution area, and the first distribution area is closer to the light incident surface than the second distribution area in the first direction, and wherein a first pitch of an optical structure in the plurality of optical structures located in the first distribution area is greater than a first pitch of an optical structure in the plurality of optical structures located in the second distribution area, and the first pitch is a distance between two adjacent optical structures in the first direction.

In some embodiments, the plurality of optical structures are arranged at intervals at least in a third direction, and the third direction is parallel to the third surface and perpendicular to the first direction.

In some embodiments, the light source module includes at least a first distribution area and a second distribution area, and the first distribution area is closer to the light incident surface than the second distribution area in the first direction, and wherein a second pitch of an optical structure in the plurality of optical structures located in the first distribution area is greater than a second pitch of an optical structure in the plurality of optical structures located in the second distribution area, and the second pitch is a distance between two adjacent optical structures in the third direction.

In some embodiments, the light source module further includes: a protection structure arranged on a side of the optical control layer away from the light guide structure; and a first bonding adhesive arranged between the optical control layer and the protection structure, wherein an orthographic projection of the first bonding adhesive on the first surface covers an orthographic projection of the plurality of optical structures on the first surface.

In some embodiments, a refractive index of the protection structure, a refractive index of the first bonding adhesive, and the refractive index of the optical control layer body are substantially equal to each other.

In some embodiments, the light source module further includes: a second bonding adhesive and a substrate, arranged between the light guide structure and the optical control layer, wherein the second bonding adhesive, the substrate, and the optical control layer are arranged away from the light guide structure sequentially.

In some embodiments, a refractive index of the second bonding adhesive, a refractive index of the substrate, and the refractive index of the optical control layer are substantially equal to each other.

In some embodiments, the refractive index of the optical control layer body is between 1.55 and 1.65.

The present disclosure provides a display module including the light source module according to the above-mentioned embodiments.

In some embodiments, the display module further includes: a display panel arranged on a side of the light guide structure away from the optical control layer, wherein the display panel is a reflective display panel, and a display surface of the display panel faces the light guiding structure.

The present disclosure provides a method for manufacturing a light source module, and the method includes: preparing a roller with a convex structure, wherein a shape of the convex structure of the roller is the same as a shape of an optical structure to be formed; and coating a material of an optical control layer on a substrate, and forming a groove in an optical control material layer by using the roller, so as to form the optical control layer including the optical structure, wherein a shape of the groove is the same as the shape of the optical structure to be formed, wherein the optical control layer includes an optical control layer body, and a refractive index of the optical control layer body is greater than a refractive index of air, the optical control layer includes a third surface and a fourth surface, and the groove is formed in the third surface, and the optical structure includes a first optical surface, a second optical surface, a third optical surface, and a fourth optical surface, and each of the first optical surface, the second optical surface, the third optical surface, and the fourth optical surface is spaced apart from the fourth surface, and the first optical surface, the second optical surface, the third optical surface, and the fourth optical surface are sequentially arranged in the first direction, and the first optical surface and the second optical surface gradually move closer toward the fourth surface, the second optical surface and the third optical surface gradually move closer toward the first surface, and the third optical surface and the fourth optical surface gradually move closer toward the fourth surface.

In some embodiments, the method further includes: filling the groove with a low refractive index material, wherein a refractive index of the low refractive index material is less than the refractive index of the optical control layer body, and the optical structure includes the groove and the low refractive index material in the groove.

### BRIEF DESCRIPTION OF THE DRAWINGS

In order to more clearly describe the technical solutions in the embodiments of the present disclosure or in related art, the following will briefly introduce the accompanying drawings that need to be used in the description of the embodiments or in the related art. Obviously, the accompanying drawings in the following description are merely some embodiments of the present disclosure, those ordinary skilled in the art can obtain other drawings based on these accompanying drawings without creative work, and in the accompanying drawings:

FIG. 1 is a cross-sectional view of a light source module according to some exemplary embodiments of the present disclosure;

FIG. 2 is a schematic plan view of an optical control layer and an optical structure included in a light source module according to some exemplary embodiments of the present disclosure;

FIG. 3 is a schematic cross-sectional view of an optical structure according to some exemplary embodiments of the present disclosure;

FIG. 4 is a schematic diagram of a display module according to some exemplary embodiments of the present disclosure, in which some light paths are schematically shown;

FIG. 5 is a light path diagram of a display module according to some exemplary embodiments of the present disclosure;

FIG. 6 is a light path diagram of a display module according to some exemplary embodiments of the present disclosure;

FIG. 7 is a schematic cross-sectional view of an optical structure according to some exemplary embodiments of the present disclosure;

FIG. 8 is a schematic view of a light source module according to some exemplary embodiments of the present disclosure, in which a depth distribution of optical structures is schematically shown;

FIG. 9 is an enlarged view of the depth distribution of the optical structures shown in FIG. 8;

FIG. 10 is a schematic diagram of a light source module according to some exemplary embodiments of the present disclosure, in which a pitch distribution of optical structures is schematically shown;

FIG. 11 is an enlarged view of the pitch distribution of the optical structures shown in FIG. 10;

FIG. 12 is a schematic diagram of a two-dimensional distribution of optical structures of a light source module according to some exemplary embodiments of the present disclosure;

FIG. 13 is a cross-sectional view of a light source module according to some exemplary embodiments of the present disclosure; and

FIG. 14 is a flowchart of a method for manufacturing a light source module according to the embodiments of the present disclosure.

It should be noted that, for clarity, in the accompanying drawings used to describe the embodiments of the present disclosure, a dimension of a layer, a structure, or a region may be enlarged or reduced, that is, these accompanying drawings are not drawn according to actual scale.

### DETAILED DESCRIPTION OF EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by those ordinary skilled in the art without creative work shall fall within the protection scope of the present disclosure.

In addition, in the following detailed description, for the convenience of explanation, many specific details are set forth to provide a comprehensive understanding of the embodiments of the present disclosure. However, obviously, one or more embodiments can also be implemented without these specific details.

It should be understood that, although terms first, second, etc. may be used herein to describe different elements, these elements should not be limited by these terms. These terms are only used to distinguish one element from another element. For example, without departing from the scope of the exemplary embodiments, a first element may be named as a second element, and similarly, the second element may be named as the first element. A term “and/or” as used herein includes any and all combinations of one or more of the related listed items.

It should be understood that when an element or a layer is referred to as being “formed on” another element or layer, the element or layer can be directly or indirectly formed on the another element or layer. That is, for example, there may be an intermediate element or an intermediate layer. In contrast, when an element or a layer is referred to as being “directly formed on” another element or layer, there are no intermediate elements or intermediate layers. Other terms used to describe relationships between elements or layers should be interpreted in a similar manner (for example, “between” and “directly between”, “adjacent” and “directly adjacent” etc.).

In the present disclosure, directional expressions “a first direction”, “a second direction”, and “a third direction” are used to describe different directions along a light source module or a display module. It should be understood that such representation is only an exemplary description, and is not a limitation to the present disclosure.

Some exemplary embodiments of the present disclosure provide a light source module. The light source module includes: a light source; a light guide structure including a light incident surface and a first surface, in which light emitted by the light source enters the light guide structure through the light incident surface; an optical control layer arranged on the first surface of the light guide structure, in which the optical control layer includes an optical control layer body, a third surface away from the light guide structure, and a fourth surface facing the light guide structure; and a plurality of optical structures arranged in the optical control layer for adjusting the light incident on the plurality of optical structures, in which the plurality of optical structures are arranged at intervals at least in a first direction, and the first direction is perpendicular to the light incident surface. Each of the plurality of optical structures includes a groove in the optical control layer, and the groove forms an opening in the third surface; and each of the plurality of optical structures includes a first optical surface, a second optical surface, a third optical surface, and a fourth optical surface. The first optical surface, the second optical surface, the third optical surface, and the fourth optical surface are spaced apart from the fourth surface of the optical control layer. The first optical surface, the second optical surface, the third optical surface, and the fourth optical surface are sequentially away from the light incident surface in the first direction. The first optical surface and the second optical surface gradually move closer in a direction toward the light guide structure. The second optical surface and the third optical surface gradually move closer in a direction away from the light guide structure. The third optical surface and the fourth optical surface gradually move closer in a direction toward the light guide structure. The groove is filled with a low refractive index material, and a refractive index of the low refractive index material is less than a refractive index of the optical control layer body. Alternatively, the groove is filled with air, the refractive index of the optical control layer body is greater than a refractive index of air. In the embodiments of the present disclosure, the light emitted from the light source is transmitted in the light guide structure and the optical control layer, and is adjusted by the plurality of optical structures, which increases the amount of light emitted from the light source and incident on components below (for example, a reflective display panel).

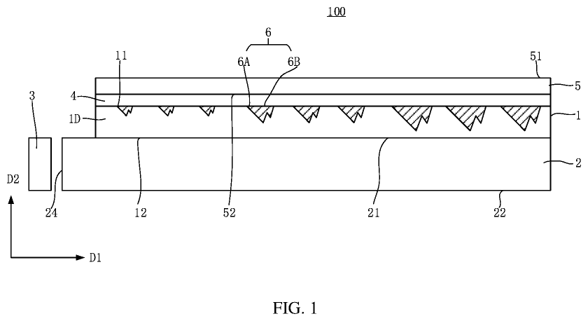

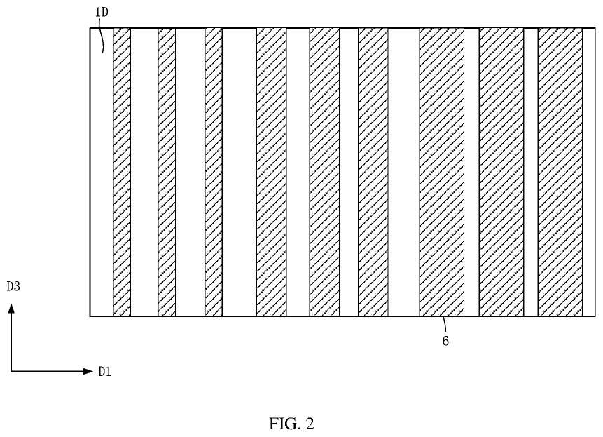

FIG. 1 is a cross-sectional view of a light source module according to some exemplary embodiments of the present disclosure, and FIG. 2 is a schematic plan view of an optical control layer and an optical structure included in a light source module according to some exemplary embodiments of the present disclosure. Referring to FIGS. 1 and 2, the light source module 100 according to the embodiments of the present disclosure may include a light source 3, a light guide structure 2, an optical control layer 1, a first bonding adhesive 4, and a protection structure 5.

As shown in FIGS. 1 and 2, the light source 3 may be arranged on a side of the light guide structure 2, for example, on a left side in FIGS. 1 and 2. The light guide structure 2 may be formed in a form of a light guide layer or a light guide plate. The light guide structure 2 may include a first surface 21, a second surface 22 and a light incident surface 24. The second surface 22 is opposite to the first surface 21, and the light incident surface 24 is connected to the first surface 21 and the second surface 22. The light source 3 is arranged opposite to the light incident surface 24, and light emitted by the light source 3 enters the light guide structure 2 through the light incident surface 24, and is transmitted in the light guide structure 2. At least a part of the light may enter the optical control layer 1 through the first surface 21, and at least a part of the light may exit through the second surface 22.

For example, the first surface 21 may be a surface of the light guide structure 2 on a side close to the optical control layer 1, that is, an upper surface in FIG. 2. The second surface 22 may be a surface of the light guide structure 2 on a side close to the display panel (which will be described below), that is, a bottom surface in FIG. 2. The first surface 21 may be substantially parallel to the second surface 22.

In the present disclosure, a line perpendicular to a certain surface is referred to as a normal line of the surface. Referring to FIG. 2, a first direction D1 is parallel to a normal line of the light incident surface 24, and a second direction D2 is parallel to a normal line of the first surface 21 or the second surface 22. Referring to FIG. 1, a third direction D3 is perpendicular to both the first direction D1 and the second direction D2.

In some embodiments, the light guide structure 2, the optical control layer 1, the first bonding adhesive 4, and the protection structure 5 may be stacked sequentially in the second direction D2. The first bonding adhesive 4 is used to bond the protection structure 5 and the optical control layer 1 together.

For example, the light source 3 may include a light-emitting diode (LED for short) or a light bar composed of a plurality of light-emitting diodes, and the embodiments of the present disclosure are not limited thereto. In other embodiments, the light source 3 may also include an organic light-emitting diode, a quantum dot light-emitting diode, a micro-light-emitting diode, a sub-millimeter light-emitting diode and other components suitable for light-emitting.

Continuing to refer to FIGS. 1 and 2, the optical control layer 1 is arranged on the first surface 21. The optical control layer 1 may include an optical control layer body 1D and a plurality of optical structures 6. The optical structure 6 is arranged on a side of the optical control layer body 1D away from the light guide structure 2, or on a side of the optical control layer body 1D away from the first surface 21 of the light guide structure 2.

The optical control layer 1 includes a third surface 11 away from the light guide structure 2 and a fourth surface 12 facing the light guide structure 2. For example, the fourth surface 12 may contact the first surface 21 of the light guide structure 2.

For example, in some embodiments, the optical structure 6 includes a groove 6A. The groove 6A is recessed from the third surface 11 of the optical control layer toward the fourth surface 12 of the optical control layer, and is formed as a trench located in the optical control layer 1 and having a predetermined depth. That is, the groove 6A forms an opening at the third surface 11 of the optical control layer 1, or in other words, the groove 6A opens at the third surface 11 of the optical control layer.

With reference to FIGS. 1 and 2 in combination, a plurality of grooves 6A are arranged at intervals in the first direction D1. For example, each of the plurality of grooves 6A may extend in the third direction D3, and an extension length of each of the plurality of grooves 6A in the third direction D3 may be less than a length of the optical control layer 1 in the third direction D3. In this case, at least two grooves 6A may be arranged at intervals in the third direction D3. In some embodiments, each of the plurality of grooves 6A may penetrate the optical control layer 1 in the third direction D3.

In some embodiments, the optical structure 6 further includes a low refractive index material 6B filled in the groove 6A. A refractive index of the low refractive index material 6B is less than a refractive index of a material of the optical control layer body 1D, and the low refractive index material 6B is, for example, low refractive index optical glue.

In some embodiments, the groove 6A may contain air. That is, the optical structure 6 includes the groove 6A and the air existing in the groove 6A. The refractive index of the material of the optical control layer body 1D may be greater than the refractive index of air.

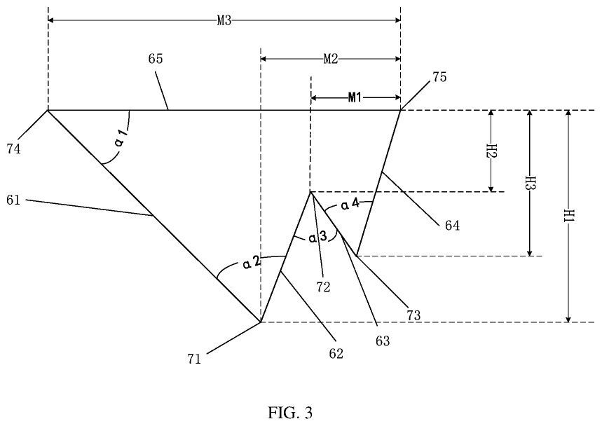

FIG. 3 is a schematic cross-sectional view of an optical structure according to some exemplary embodiments of the present disclosure. The optical structure 6 includes a first optical surface 61, a second optical surface 62, a third optical surface 63, a fourth optical surface 64, and a fifth optical surface 65. With reference to FIGS. 1 to 3 in combination, the first optical surface 61, the second optical surface 62, the third optical surface 63, and the fourth optical surface 64 are in turn away from the light incident surface 24, and the first optical surface 61, the second optical surface 62, the third optical surface 63, and the fourth optical surface 64 are connected in turn. The fifth optical surface 65 connects the first optical surface 61 and the fourth optical surface 64. The fifth optical surface 65 may be substantially parallel to the third surface 11 of the optical control layer 1. In some embodiments, when the groove 6A is filled with the low refractive index material 6B, the fifth optical surface 65 may be a top surface of the low refractive index material 6B, coplanar with the third surface 11 of the optical control layer 1. In some embodiments, when the groove 6A is not filled with the low refractive index material 6B, that is, when the groove 6A contains air, the fifth optical surface 65 is a virtual surface coplanar with the third surface 11 of the optical control layer.

In some embodiments, the first optical surface 61, the second optical surface 62, the third optical surface 63, and the fourth optical surface 64 are spaced apart from the fourth surface 12 of the optical control layer 11, that is, the first optical surface 61, the second optical surface 62, the third optical surface 63, and the fourth optical surface 64 are separated from the fourth surface 12 of the optical control layer 1 by a distance in the second direction D2. In other words, the groove 6A does not penetrate the optical control layer 1, and a depth of the groove 6A is less than a thickness of the optical control layer. The fifth optical surface 65 is coplanar with the third surface 11 of the optical control layer 1. The depth of the groove 6A refers to a dimension of the groove 6A in the second direction D2.

In the embodiments of the present disclosure, as shown in FIGS. 1 to 3, the first optical surface 61 and the second optical surface 62 gradually move closer in a direction toward the light guide structure 2, and the second optical surface 62 and the third optical surface 63 gradually moves closer in a direction away from the light guide structure, and the third optical surface 63 and the fourth optical surface 64 gradually move closer in the direction toward the light guide structure. The first optical surface 61 and the second optical surface 62 converge at a first intersection line 71, the second optical surface 62 and the third optical surface 63 converge at a second intersection line 72, and the third optical surface 63 and the fourth optical surface 64 converge at a third intersection line 73. The first intersection line 71, the second intersection line 72, and the third intersection line 73 are parallel to each other, and the first intersection line 71, the second intersection line 72, and the third intersection line 73 are parallel to the third surface 11 of the optical control layer 1 and are perpendicular to the first direction D1, that is, extend in the third direction D3. The first intersection line 71, the second intersection line 72, and the third intersection line 73 are all located on a side of the third surface 11 close to the fourth surface 12 and located between the third surface 11 and the fourth surface 12. The first optical surface 61 and the fifth optical surface intersect at a fourth intersection line 74, and the fourth optical surface 64 and the fifth optical surface 65 intersect at a fifth intersection line 75. It may also be understood as the first optical surface 61 and the third surface 11 of the optical control layer 1 intersect at the fourth intersection line 74, and the fourth optical surface 64 and the third surface 11 of the optical control layer 1 intersect at the fifth intersection line 75. The fourth intersection line 74 and the fifth intersection line 75 also extend in the third direction D3.

As shown in FIG. 3, an included angle between the first optical surface 61 and the fifth optical surface 65 is a first included angle α1, an included angle between the first optical surface 61 and the second optical surface 62 is a second included angle α2, an included angle between the second optical surface 62 and the third optical surface 63 is a third included angle α3, and an included angle between the third optical surface 63 and the fourth optical surface 64 is a fourth included angle α4. The first included angle α1, the second included angle α2, the third included angle α3, and the fourth included angle α4 satisfy the following formula:

0°<α1,α2,α3,α4<0°.

That is, the first included angle α1, the second included angle α2, the third included angle α3, and the fourth included angle α4 are acute angles.

A distance between the first intersection line 71 and the fifth optical surface 65 is a first distance H1, a distance between the second intersection line 72 and the fifth optical surface 65 is a second distance H2, and a distance between the third intersection line 73 and the fifth optical surface 65 is a third distance H3. The first distance H1, the second distance H2, and the third distance H3 satisfy the following formula:

H1>H3>H2>0.

A distance between the second intersection line 72 and the fifth intersection line 75 in the first direction D1 is a fourth distance M1, and a distance between the first intersection line 71 and the fifth intersection line 75 in the first direction D1 is a fifth distance M2, a distance between the fourth intersection line 74 and the fifth intersection line 75 in the first direction D1 is a sixth distance M3. The fourth distance M1, the fifth distance M2, and the sixth distance M3 satisfy the following formula:

M3>M2>M1>0.

In some embodiments, the first optical surface 61, the second optical surface 62, the third optical surface 63, and the fourth optical surface 64 are connected sequentially. As shown in FIGS. 1 and 3, each groove has a bend line shape similar to “W”, that is, an orthographic projection of each groove 6A on a plane formed by the first direction D1 and the second direction D2 presents a bending line shape similar to “W”.

In some embodiments, the first optical surface 61, the second optical surface 62, the third optical surface 63, the fourth optical surface 64, and the fifth optical surface 65 are all flat surfaces.

In the embodiments of the present disclosure, a refractive index of the optical control layer body 1D may be greater than a refractive index of the low refractive index material 6B or air, that is, the optical control layer body 1D may be formed of a high refractive index material. For example, the refractive index of the optical control layer body 1D may be between 1.55 and 1.65. The refractive index of the low refractive index material 6B may be between 1 and 1.2, and the refractive index of air is around 1. For example, a material of the optical control layer body 1D may include UV glue (i.e., ultraviolet light curable optical glue). A thickness (a dimension in the second direction D2) of the optical control layer body 1D may be between 10 and 30 μm.

In some embodiments, a refractive index of the light guide structure 2 may be close to the refractive index of the optical control layer body 1D, that is, the refractive index of the light guide structure 2 and the refractive index of the optical control layer body 1D may be approximately equal. For example, the refractive index of the light guide structure 2 may be between 1.55 and 1.65. A material of the light guide structure 2 may include polycarbonate (PC), polymethyl methacrylate (PMMA) or other transparent high refractive index light guide materials. The light guide structure 2 may play a role in guiding light, and guide the light emitted by the light source 3 into the light source module, a thickness of the light guide structure 2 is, for example, 0.05 to 0.5 mm. In addition, the light guide structure 2 may also play a role of supporting various film layers. The light guide structure 2 may have a certain degree of bendability. In some embodiments, the light guide structure 2 may be directly used as a substrate on which the optical control layer 1 is formed. In this case, UV glue may be directly formed on the light guide structure 2 and the optical control layer 1 may be formed through processes such as patterning and curing.

Therefore, the substrate for the optical control layer 1 may be omitted.

As shown in FIG. 1, the protection structure 5 of the light source module is arranged on a side of the optical control layer 1 away from the light guide structure 2, and is used to protect the optical structure 6, the optical control layer 1, the light guide structure 2 and other components below. The first bonding adhesive 4 is arranged between the optical control layer 1 and the protection structure 5 for bonding the protection structure 5 and the optical control layer 1. An orthographic projection of the first bonding adhesive 4 on the first surface 21 of the light guide structure 2 covers an orthographic projection of the plurality of optical structures 6 on the first surface 21 of the light guide structure 2. When the groove 6A is filled with the low refractive index material 6B, a bonding area between the protection structure 5 and the optical control layer 1 containing the low refractive index material 6B may be increased, so that the protection structure 5 and the optical control layer 1 are more firmly bonded.

The refractive index of the protection structure 5 may be close to the refractive index of the optical control layer body 1D, that is, the refractive index of the protection structure 5 and the refractive index of the optical control layer body 1D may be approximately equal. For example, the refractive index of the protection structure 5 may be between 1.55 and 1.65. A material of the protection structure 5 may include polycarbonate (PC), polymethyl methacrylate (PMMA) or other transparent high refractive index materials. For example, a thickness (a dimension in the second direction D2) of the protection structure 5 may be between 0.05 and 0.2 mm.

The protection structure 5 includes a first protection surface 51 and a second protection surface 52. The first protection surface 51 is located on a side of the protection structure 5 away from the optical control layer 1, and the second protection surface 52 is located on a side of the protection structure 5 close to the optical control layer 1.

A refractive index of the first bonding adhesive 4 may be close to the refractive index of the optical control layer body 1D, that is, the refractive index of the first bonding adhesive 4 and the refractive index of the optical control layer body 1D may be approximately equal. For example, the refractive index of the first bonding adhesive 4 may be between 1.55 and 1.65. A material of the first bonding adhesive 4 may include UV glue. For example, a thickness (a dimension in the second direction D2) of the first bonding adhesive 4 may be about 2 μm.

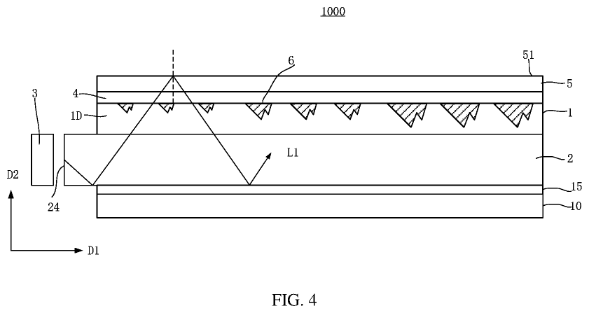

FIG. 4 is a schematic diagram of a display module according to some exemplary embodiments of the present disclosure. Referring to FIG. 4, the display module 1000 according to the embodiments of the present disclosure may include the light source module 100 described above and a display panel 10. The display panel 10 may be a reflective display panel. The display panel 10 may be bonded to the light source module 100 through an adhesive layer 15. For example, the adhesive layer 15 may include pressure sensitive adhesive (PSA) or optical clear adhesive (OCA). The adhesive layer 15 may be a transparent adhesive layer. The adhesive layer 15 is also referred to as a third bonding adhesive herein. A refractive index of the adhesive layer 15 may be less than or substantially equal to the refractive index of the light guide structure 2. In the subsequent description of an optical path, the refractive index of the adhesive layer 15 less than the refractive index of the light guide structure 2 and the refractive index of the optical control layer 1 is taken as an example.

The reflective display panel may be a reflective liquid crystal display panel, an electronic ink display panel, or a reflective display panel based on electro-wetting, which is not particularly limited in the embodiments of the present disclosure. For example, the display panel 10 may include a liquid crystal cell, and based on a liquid crystal display mode, specific examples of the liquid crystal cell may include: twisted or non-twisted liquid crystal cell, such as TN (twisted nematic) liquid crystal cell, STN (super twisted nematic) liquid crystal cell, VA (vertical alignment) liquid crystal cell, etc.

The display panel 10 is located on a side of the light guide structure 2 away from the optical control layer 1. A display side of the display panel 10 is provided with the light guide structure 2. For the convenience of description, a side of the protection structure 5 away from the display panel 10 is referred to as the display side of the display module, and s side of the display panel 10 away from the protection structure 5 is referred to as a back side of the display module.

FIG. 4 shows some light transmission paths in the backlight module. As shown in FIG. 4, as described above, the refractive index of the light guide structure 2, the refractive index of the optical control layer 1, the refractive index of the first bonding adhesive 4, and the refractive index of the protection structure 5 are substantially the same, and they are high refractive index. A part of the light incident from the light source 3 into the light guide structure 2, for example, light L1 may be totally reflected between the second surface 22 of the light guide structure 2 and the first protection surface 51 of the protection structure 5 without passing through the optical structure 6. The light L1 propagates in the first direction D1 until it is incident on the optical structure 6 and is adjusted by the optical structure 6. For example, for light propagating in an overall structure consisting of the light guide structure 2, the optical control layer 1, the first bonding adhesive 4 and the protection structure 5, a critical angle for total reflection at the first protection surface 51 is (30, for example, (30 may be equal to about 39°. According to a total reflection formula, when an included angle between the light incident on the first protection surface 51 and a normal direction at the first protection surface 51 is greater than or equal to the critical angle (30, the light may be totally reflected at the first protection surface 51. A critical angle at which total reflection occurs at the second surface 22 of the light guide structure 2 is (30′, for example, (30′ may be equal to about 39°. According to the total reflection formula, when an included angle between the light incident on the second surface 22 of the light guide structure 2 and a normal direction at the second surface 22 of the light guide structure 2 is greater than or equal to the critical angle (30, the light may be totally reflected at the second surface 22 of the light guide structure 2.

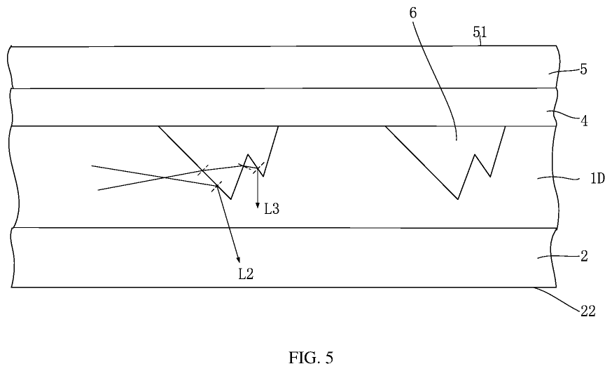

FIG. 5 is a light path diagram of a display module according to some exemplary embodiments of the present disclosure, in which light paths of some light incident to the optical structure are schematically shown.

For example, referring to light L2 shown in FIG. 5, the light L2 traveling in the optical control layer body 1D is incident on the first optical surface 61 of the optical structure 6 and is totally reflected at the first optical surface 61. A critical angle at which total reflection occurs at the first optical surface 61 is (3, for example, (3 may be equal to about 39°. According to the total reflection formula, when an included angle between the light incident on the first optical surface 61 and a normal direction at the first optical surface 61 is greater than or equal to the critical angle (3, the light may be totally reflected at the first optical surface 61. An included angle between the light L2 and a normal direction at the first optical surface 61 is greater than or equal to the critical angle (3, and the light L2 travels toward the second surface 22 of the light guide structure 2 after being totally reflected at the first optical surface 61. An included angle between the light L2 and a normal at the second surface 22 of the light guide structure 2 is less than the critical angle (30′, and the light L2 exits from the second surface 22 of the light guide structure 2, and then enters the display panel 10 to provide display light for the display panel.

For example, referring to light L3 shown in FIG. 5, the light L3 traveling in the optical control layer body 1D is incident on the first optical surface 61 of the optical structure 6, and an included angle between the light L3 and the normal direction at the first optical surface 61 is less than the critical angle (3, the light L3 is refracted at the first optical surface 61 and enters the optical structure 6. After the light L3 propagates in the optical structure 6, it is refracted at the second optical surface 62 of the optical structure 6 and enters the optical control layer body 1D again. Since the refraction at the second optical surface 62 is from a light-thin medium to a light-dense medium, the light L3 emitted from the second optical surface 62 may be incident on the third optical surface 63 at a larger angle. A critical angle at which total reflection occurs at the third optical surface 63 is also (3, for example, (3 may be equal to about 39°. An included angle between the light L3 and a normal direction at the third optical surface 63 is greater than or equal to the critical angle (3, and the light L3 is totally reflected at the third optical surface 63 and then travels toward the second surface 22 of the light guide structure 2. An included angle between the light L3 and a normal at the second surface 22 of the light guide structure 2 is less than the critical angle (30′, and the light L3 exits from the second surface 22 of the light guide structure 2, and then enters the display panel 10 to provide display light for the display panel.

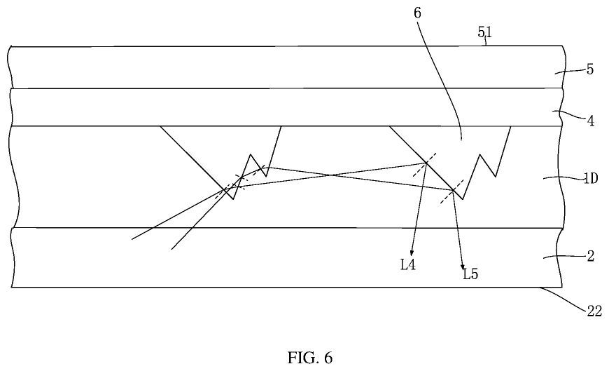

FIG. 6 is a light path diagram of a display module according to some exemplary embodiments of the present disclosure, in which light paths of some light incident to the optical structure are schematically shown.

For example, referring to light L4 shown in FIG. 6, the light L4 traveling in the optical control layer body 1D is incident on the first optical surface 61 of the optical structure 6, and an included angle between the light L4 and the normal direction at the first optical surface 61 is less than the critical angle (3, the light L4 is refracted at the first optical surface 61 and enters the optical structure 6. After the light L4 propagates in the optical structure 6, it is refracted at the second optical surface 62 of the optical structure 6 and enters the optical control layer body 1D again. A direction in which the light L4 travels in the optical control layer body 1D after passing through the optical structure 6 is deflected from a direction in which the light L4 travels in the optical control layer body 1D before entering the optical structure 6, for example deflecting toward the second surface 22 of the light guide structure 2. The light L4 does not pass through the third optical surface 63 of the optical structure 6 and the fourth optical surface 64 of the optical structure 6. The light L4 continues to travel in the optical control layer body 1D, enters a first optical surface 61 of another optical structure 6, and is totally reflected at the first optical surface 61 of the another optical structure 6, and then travels toward the second surface 22 of the light guide structure 2. An included angle between the light L4 and a normal at the second surface 22 of the light guide structure 2 is less than the critical angle (30′, and the light L4 exits from the second surface 22 of the light guide structure 2, and then enters the display panel 10 to provide display light for the display panel.

For example, referring to light L5 shown in FIG. 6, the light L5 traveling in the optical control layer body 1D is incident on the first optical surface 61 of the optical structure 6, and an included angle between the light L5 and the normal direction at the first optical surface 61 is less than the critical angle (3, for example, the light L5 is incident perpendicular to the first optical surface 61, the light L5 is refracted at the first optical surface 61 and enters the optical structure 6. The light L5 propagates in the optical structure 6, and is refracted at the second optical surface 62 of the optical structure 6, and enters the optical control layer body 1D again. Subsequently, the light L5 is incident on the third optical surface 63 of the optical structure 6, and an included angle between the light L5 and a normal direction at the third optical surface 63 is less than the critical angle (3, and the light L5 is refracted again at the third optical surface 63, and enters the optical structure 6 again. The light L5 propagates in the optical structure 6, and is refracted at the fourth optical surface 64 of the optical structure 6, and enters the optical control layer body 1D again. A direction in which the light L5 travels in the optical control layer body 1D after passing through the optical structure 6 is deflected from a direction in which the light L5 travels in the optical control layer body 1D before entering the optical structure 6, for example, deflecting toward the second surface 22 of the light guide structure 2. The light L5 continues to travel in the optical control layer body 1D, and is incident on a first optical surface 61 of another optical structure 6, and is totally reflected at the first optical surface 61 of the another optical structure 6, and travels toward the second surface 22 of the light guide structure 2. An included angle between the light L5 and a normal at the second surface 22 of the light guide structure 2 is less than the critical angle (30′, and the light L5 exits from the second surface 22 of the light guide structure 2, and then enters the display panel 10 to provide display light for the display panel.

In some embodiments, some light emitted from the light source 3 is adjusted by the optical structure 6. After passing through the optical structure 6, some light does not satisfy a condition of total reflection at the second surface 2 of the light guide structure 2, and exits from the second surface 2 of the light guide structure 2, and then enters the display panel 10 to provide display light for the display panel. The other light is adjusted by the optical structure 6, and after passing through the optical structure 6, the other light satisfies the condition of total reflection at the second surface 2 of the light guide structure 2, and the other light continues to propagate in the overall structure consisting of the light guide structure 2, the optical control layer 1, the first bonding adhesive 4 and the protection structure 5, and may be adjusted by other optical structures 6.

In some embodiments, the light incident into the display panel 10 is reflected by the display panel and propagates toward the display side of the display module. In the embodiments of the present disclosure, the light emitted from the light source 3 is adjusted by the optical structure 6, which increases the amount of light emitted from the light source 3 and incident on the display panel 10 below, thereby enhancing brightness of the display panel 10, which is beneficial to improve a display effect of the display module when an external environment light is insufficient.

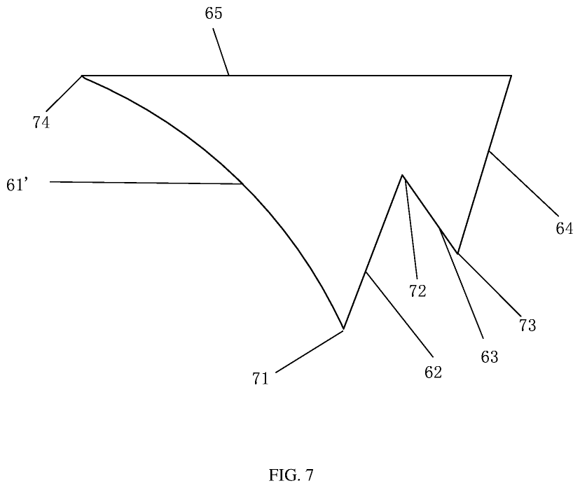

FIG. 7 is a schematic cross-sectional view of an optical structure according to some exemplary embodiments of the present disclosure. The optical structure is substantially the same as that of the optical structure 6 shown in FIG. 3, except that a first optical surface 61′ is a curved surface, for example, a curved surface. As shown in FIG. 7, the first optical surface 61′ is a concave arc surface that is recessed toward inside of the optical structure 6, and a radius of curvature R is, for example, 35 μm to 40 μm. The inside of the optical structure 6 refers to an inside of the groove 6A surrounded by the first optical surface 61, the second optical surface 62, the third optical surface 63, and the fourth optical surface 64. Compared with the above-mentioned embodiments in which the first optical surface is a plane, the optical structure 6 in this embodiment may use more angles of light, which improves a light efficiency utilization rate.

In the embodiments of the present disclosure, a luminous flux of light emitted from the light source 3 and incident on the display panel 10 below is indicated as a first luminous flux Q 1. A luminous flux of light emitted from the light source 3 and not incident on the display panel 10 below but directly emitted from the protection structure 5 is indicated as Q2. A luminous efficiency ratio is Q0=Q1/Q2, that is, the luminous efficiency ratio is a ratio of the first luminous flux to the second luminous flux. The greater the luminous efficiency ratio Q0, the more effectively the light emitted by the light source 3 is used, and the more beneficial it is to improve the brightness of the display module.

In the embodiments of the present disclosure, based on the structures shown in FIGS. 1 to 6, in a case that a thickness and refractive index of each component or film layer remain unchanged, the above-mentioned light efficiency ratio Q0 and the first included angle α1, the second included angle α2, the third included angle α3, the fourth included angle α4, and the radius of curvature R have a certain functional relationship.

The following evaluation function may be established:

MF=Target-f(α1,α2,α3,α4,R),

MF is an evaluation function, Target is a target value to which the luminous flux is to be optimized, f (α1,α2,α3,α4,H1,H2,H3,M1,M2,M3,R) indicates a function with the first included angle α1, the second included angle α2, the third included angle α3, the fourth included angle α4, and the radius of curvature R as variables.

The Monte Carlo Pathing Tracing algorithm may be used to cause the evaluation function MF to approach 0 as much as possible. At this time, the target value to which the luminous flux is to be optimized reaches a maximum value, so as to obtain an optimal solution of the first included angle α1, the second included angle α2, and the third included angle α3, the fourth included angle α4, and the radius of curvature R. For example, the target value Target is initially an initial value, for example, an absolute value of the first luminous flux Q1 may be 2, and an absolute value of the second luminous flux Q2 may be 10. A set of α1, α2, α3, α4, R is calculated; and then the target value Target is gradually changed (the first luminous flux Q1 is increased, and the second luminous flux Q2 is decreased), and α1, α2, α3, α4, and R are calculated, respectively, until there is no solution for α1, α2, α3, α4, and R. For example, in an exemplary embodiment, an optimal solution of the first included angle α1 and the second included angle α2 is:

α1=29.5°α2=37.5°α3=64°α4=64°R=37 μm

It should be understood that when a stack of the display module, a refractive index of each film layer constituting the stack, etc. change, an optimal solution of the above-mentioned α1, α2, α3, α4, H1, H2, H3, M1, M2, M3, R is changed accordingly.

In the embodiments of the present disclosure, the first included angle α1, the second included angle α2, the third included angle α3, and the fourth included angle α4 may vary within a range of ±2° of the above-mentioned optimal solution, for example, the first included angle α1 may be in a range of 27.5° to 31.5°, the second included angle α2 may be in a range of 35.5° to 39.5°, the third included angle α3 may be in a range of 62° to 66°, the fourth included angle α4 may be in a range of 62° to 66°, and the radius of curvature R may be varied within a range of ±2 μm of the above-mentioned optimal solution. For example, the radius of curvature R may be in a range of 35 to 39 μm.

In this way, values of the first included angle α1, the second included angle α2, the third included angle α3, the fourth included angle α4, and the radius of curvature R may ensure that the above-mentioned light efficiency ratio Q0 is large, thereby effectively improving the brightness of the display module.

In some embodiments, values of the first distance H1, the second distance H2, the third distance H3, the fourth distance M1, the fifth distance M2, and the sixth distance M3 are, for example, H1=14 μm±2 μm, H2=6 μm±2 μm M1=3.8 μm±2 μm, M2=5.2 μm±2 μm, M3=19.2 μm±2 μm.

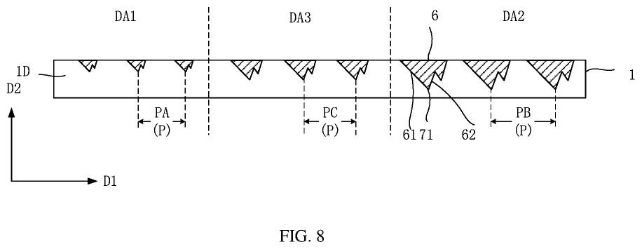

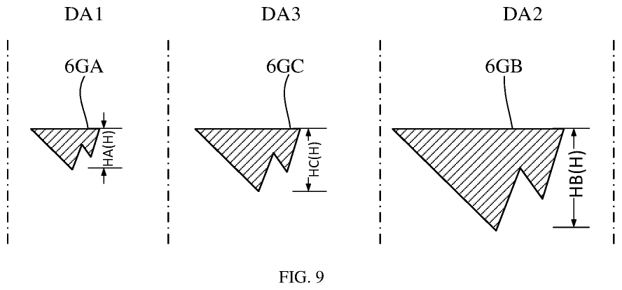

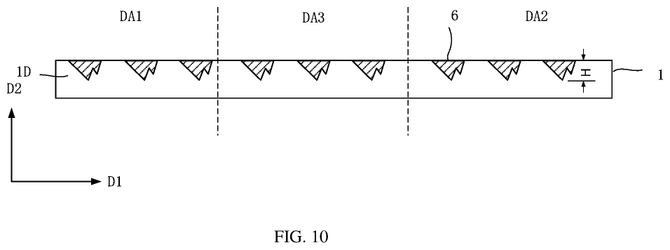

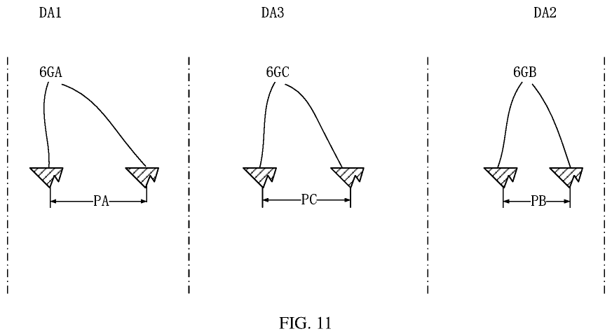

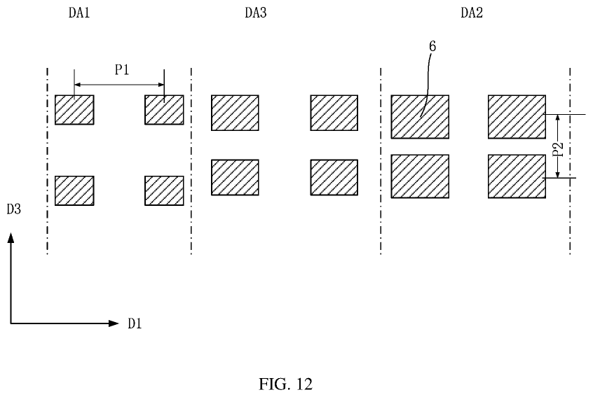

FIG. 8 is a schematic diagram of a light source module according to some exemplary embodiments of the present disclosure, in which a depth distribution of optical structures is schematically shown. FIG. 9 is an enlarged view of the depth distribution of the optical structures shown in FIG. 8. FIG. 10 is a schematic diagram of a light source module according to some exemplary embodiments of the present disclosure, in which a pitch distribution of optical structures is schematically shown. FIG. 11 is an enlarged view of the pitch distribution of the optical structures shown in FIG. 10. FIG. 12 is a schematic diagram of a light source module according to some exemplary embodiments of the present disclosure, in which the depth distribution and the pitch distribution of the optical structures are schematically shown.

With reference to FIGS. 1 to 12 in combination, in the embodiments of the present disclosure, a plurality of optical structures 6 are distributed at intervals in the first direction D1. Each optical structure 6 has a depth H, and the depth H is a dimension of the optical structure 6 in the second direction D2, that is, the first distance H1 in FIG. 3. A distance between two adjacent optical structures 6 is a pitch P of the optical structure 6. For example, for an optical structure 6, the first optical surface 61 and the second optical surface 62 intersect at a first intersection line 71, and the first intersection line 71 may also be referred to as a top line. The pitch P may be equal to a distance between top lines 71 of two adjacent optical structures 6 in the first direction D1.

For example, the light source module 100 includes a plurality of distribution areas. In FIGS. 8 and 9, three distribution areas DA1, DA2, and DA3 are schematically shown. The first distribution area DA1 is close to the light incident surface 24, the second distribution area DA2 is far away from the light incident surface 24, and the third distribution area DA3 is located between the first distribution area DA1 and the second distribution area DA2.

It should be noted that, in the illustrated embodiments, the three distribution areas are schematic illustrations, and do not constitute a special limitation to the embodiments of the present disclosure. In other embodiments of the present disclosure, the light source module 100 may include a smaller number. (e.g., two) or more (e.g., four, five or more) distribution areas.

At least one optical structure 6 is located in the first distribution area DA1, at least one optical structure 6 is located in the third distribution area DA3, and at least one optical structure 6 is located in the second distribution area DA2. For the convenience of description, the optical structure 6 located in the first distribution area DA1 is referred to as a first optical structure 6GA, and the optical structure 6 located in the second distribution area DA2 is referred to as a second optical structure 6GB, the optical structure 6 located in the third distribution area DA3 is referred to as a third optical structure 6GC. Accordingly, a depth of the first optical structure 6GA may be indicated by HA, and a pitch of the first optical structure 6GA may be indicated by PA; a depth of the second optical structure 6GB may be indicated by HB, and a pitch of the second optical structure 6GB may be indicated by PB; and a depth of the third optical structure 6GC may be indicated by HC, and a pitch of the third optical structures 6GC may be indicated by PC.

In some embodiments, a plurality of first optical structures 6GA may be provided in the first distribution area DA1, a plurality of second optical structures 6GB may be provided in the second distribution area DA2, and a plurality of third optical structures 6GC may be provided in the third distribution area DA3.

In the embodiments, a cross-section of an optical structure provided in each of the distribution areas may have a same pattern as that of another of the distribution areas. For example, each of the first optical structure 6GA, the second optical structure 6GB, and the third optical structure 6GC may have a cross-sectional shape as shown in FIG. 3 or FIG. 6, and their cross-sectional shapes are similar, that is, the cross-sectional shapes are in a predetermined ratio, for example, a cross-sectional shape of the second optical structure 6GB and a cross-sectional shape of the third optical structure 6GC are enlarged in a predetermined ratio with respect to a cross-sectional shape of the first optical structure 6GA, and the cross-sectional shape of the second optical structure 6GB is enlarged in a predetermined ratio with respect to the cross-sectional shape of the third optical structure 6GC.

For example, the depths HA of the plurality of first optical structures 6GA are equal to each other, and the pitches PA of the plurality of first optical structures 6GA are equal to each other. The depths HB of the plurality of second optical structures 6GB are equal to each other, and the pitches PB of the plurality of second optical structures 6GB are equal to each other. The depths HC of the plurality of third optical structures 6GC are equal to each other, and the pitches PC of the plurality of third optical structures 6GC are equal to each other.

For example, in some embodiments of the present disclosure, the pitch PA of the first optical structure 6GA may be equal to the pitch PC of the third optical structure 6GC, and the pitch PC of the third optical structure 6GC may be equal to the pitch PB of the second optical structure 6GB.

In some embodiments of the present disclosure, the depth HA of the first optical structure 6GA is less than the depth HC of the third optical structure 6GC, and the depth HC of the third optical structure 6GC is less than the depth HB of the second optical structure 6GB.

In the embodiments of the present disclosure, since a total amount of light on a side close to the light incident surface 24 is larger, the depth of the optical structure located in the first distribution area DA1 is set to be smaller, so that a proportion of the amount of light extracted by the first optical structure 6GA is smaller. A total amount of light on a side away from the light incident surface 24 is smaller, and the depth of the optical structure in the second distribution area DA2 is set to be larger, so that a proportion of the amount of light extracted by the second optical structure 6GB is larger. A case in the third distribution area DA3 is between the case in the first distribution area DA1 and the case in the second distribution area DA2. In this way, the light distribution in each distribution area of the display module may be made more even, so that the uniformity of the display module may be improved.

With reference to FIGS. 10 and 11 in combination, in some embodiments of the present disclosure, a cross-section of an optical structure provided in each of the distribution areas may have a same pattern as that of another of the distribution areas. For example, the first optical structure 6GA, the second optical structure 6GB, and the third optical structure 6GC may have a cross-sectional shape as shown in FIG. 3 or FIG. 6, and a cross-sectional shape of the first optical structure 6GA, a cross-sectional shape of the second optical structure 6GB, and a cross-sectional shape of the third optical structure 6GC have a same dimension, that is, a ratio between them is 1:1:1, that is, the depth HA of the first optical structure 6GA, the depth HC of the third optical structure 6GC, and the depth HB of the second optical structures 6GB may be equal to each other. The pitch PA of the first optical structure 6GA may be greater than the pitch PC of the third optical structure 6GC, and the pitch PC of the third optical structure 6GC may be greater than the pitch PB of the second optical structure 6GB. That is, the optical structures 6 are distributed sparsely on a side close to the light incident surface 24 and distributed densely on a side away from the light incident surface 24. In other words, the optical structures 6 are arranged from the side close to the light incident surface 24 to the side away from the light incident surface 24 in a sparse manner to a dense manner.

For example, assuming that a total luminous flux is Q and a number of distribution areas is N, a total luminous flux A extracted by each distribution area may be equal to Q/N. In a distribution area, in a direction away from the light source, a plurality of optical structures may be referred to as a first optical structure, a second optical structure, a third optical structure, etc. in turn, and so on. A light extraction efficiency of the first optical structure is c, and a light extraction efficiency of the second optical structure is d. In a case that the structure and dimension of each optical structure are substantially the same, the light extraction efficiency of each optical structure is substantially the same. A luminous flux extracted by the first optical structure is A*c, a luminous flux extracted by the second optical structure is [A-(A*c)]*d, and so on, that is, the luminous flux that may be extracted by each optical structure decreases in a direction away from the light incident surface 24. In the above-mentioned embodiments, the optical structures 6 are arranged from the side close to the light incident surface 24 to the side away from the light incident surface 24 in a sparse manner to a dense manner, so that the light distribution in each distribution area of the display module is more even. Thus, the uniformity of the display module may be improved.

In some embodiments, an optical structure in each of the distribution areas may have a depth and a pitch different from those of an optical structure in another of the distribution areas. The depth HA of the first optical structure 6GA is less than the depth HC of the third optical structure 6GC, and the depth HC of the third optical structure 6GC is less than the depth HB of the second optical structure 6GB. The pitch PA of the first optical structure 6GA may be greater than the pitch PC of the third optical structure 6GC, and the pitch PC of the third optical structure 6GC may be greater than the pitch PB of the second optical structure 6GB. In this way, the light distribution in each distribution area of the display module is made more even, so that the uniformity of the display module may be improved.

In a specific design, a number of distribution areas may be determined first according to factors such as the dimension of the display module and the process feasibility; then the luminous flux distribution in each distribution area is determined according to the total luminous flux and the number of distribution areas; and then a dimension of the optical structure in each distribution area is determined (for example, the above-mentioned depth and pitch, etc.) according to the luminous flux distribution in each distribution area.

For example, in the embodiments of the present disclosure, the pitch of the optical structure in each distribution area may be greater than or equal to 30 micrometers and less than or equal to 300 micrometers. The inventor found through research that if the pitch of the optical structure is greater than 300 micrometers, the distribution of the optical structure will be sparse, resulting in uneven brightness during display of the display module; if the pitch of the optical structure is less than 30 micrometers, it will cause difficulty in a manufacturing process, aggravate inhomogeneity, and be unfavorable for a single optical structure to function.

For example, in the exemplary embodiments, the light source module 100 includes 3 distribution areas. A pitch of an optical structure in one of the three distribution areas is equal to that of an optical structure in another of the three distribution areas, for example, the pitch is 100 micrometers. The depth of the optical structure in the first distribution area may be about 4 micrometers, the depth of the optical structure in the second distribution area may be about 9 micrometers, and the depth of the optical structure in the third distribution area may be about 14 micrometers. In this embodiment, the uniformity of the display module may reach more than 60%.

For example, in the embodiments of the present disclosure, the light source module 100 may include two distribution areas, a distribution area is close to the light incident surface 24 and another distribution area is away from the light incident surface 24. A depth of an optical structure 6 located in the distribution area close to the light incident surface 24 may be less than a depth of an optical structure 6 located in the distribution area away from the light incident surface 24, and/or a pitch of the optical structure 6 located in the distribution area close to the light incident surface 24 may be less than a pitch of the optical structure 6 located in the distribution area away from the light incident surface 24.

FIG. 12 is a schematic diagram of a two-dimensional distribution of optical structures of a light source module according to some exemplary embodiments of the present disclosure.

For example, in the embodiments of the present disclosure, orthographic projections of the plurality of optical structures 6 on the optical control layer 1 may be two-dimensionally distributed, that is, arranged at intervals in the first direction D1 and the third direction D3, and the plurality of optical structures 6 have a cross-sectional shape as shown in FIG. 3 or FIG. 6.

In a case of a two-dimensional distribution of optical structures, a distance between two adjacent optical structures 6 in the first direction D1 is a first pitch of the optical structure 6, denoted by P1; a distance between two adjacent optical structures 6 in the third direction D3 is a second pitch of the optical structure 6, denoted by P2.

With reference to FIGS. 1 to 12, the light source module 100 may include at least two distribution areas, a distribution area is close to the light incident surface 24, and the other distribution area is away from the light incident surface 24. A depth of an optical structure 6 located in the distribution area close to the light incident surface 24 may be less than a depth of an optical structure 6 located in the distribution area away from the light incident surface 24, and/or a first pitch P1 of the optical structure 6 located in the distribution area close to the light incident surface 24 may be greater than a first pitch P1 of the optical structure 6 located in the distribution area away from the light incident surface 24, and/or a second pitch P2 of the optical structure 6 located in the distribution area close to the light incident surface 24 may be greater than a second pitch P2 of the optical structure 6 located in the distribution area away from the light incident surface 24.

For example, as shown in FIG. 12, an orthographic projection of the optical structure 6 located in the first distribution area DA1 on the light guide structure 2 may be rectangular, an orthographic projection of the optical structure 6 located in the second distribution area DA2 on the light guide structure 2 may be rectangular, and an orthographic projection of the optical structure 6 located in the third distribution area DA3 on the light guide structure 2 may be rectangular.

An area of the orthographic projection of each optical structure 6 located in the first distribution area DA1 on the light guide structure 2 may be less than an area of the orthographic projection of each optical structure 6 located in the third distribution area DA3 on the light guide structure 2. An area of the orthographic projection of each optical structure 6 located in the third distribution area DA3 on the light guide structure 2 may be less than an area of the orthographic projection of each optical structure 6 located in the second distribution area DA2 on the light guide structure 2.

In the embodiments of the present disclosure, through the refractive index matching between various film layers of the light source module, combined with the adjustment of the optical structure, more light from the light source may be effectively irradiated onto the reflective display panel through the light guide plate. Thus, the display quality may be improved. In addition, by designing the dimension (such as depth, pitch, etc.) of the optical structure, the brightness uniformity of the display module may be improved, thereby further improving the display quality.

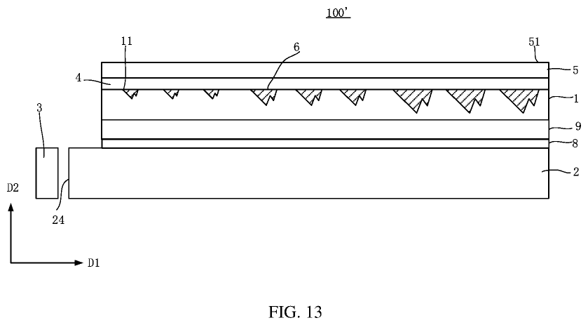

FIG. 13 is a cross-sectional view of a light source module according to some exemplary embodiments of the present disclosure. The basic structure of the display module in FIG. 13 is substantially the same as the structure of the display module in FIG. 1. Different from FIG. 1, in FIG. 13, the backlight module 100′ further provides a substrate 9 and a second bonding adhesive 8 between the light guide structure 2 and the optical control layer 1. The second bonding adhesive 8, the substrate 9 and the optical control layer 1 are arranged away from the light guide structure 2 sequentially.

The optical control layer body 1D is formed by UV glue. The UV glue material is coated on the hard substrate 9 and is patterned and then cured to form the optical control layer body 1D. The second bonding adhesive 8 bonds the substrate 9 on which the optical control layer 1 is formed and the light guide structure 2 together.

In some embodiments, a refractive index of the substrate 9 may be close to the refractive index of the optical control layer body 1D, that is, the refractive index of the substrate 9 and the refractive index of the optical control layer body 1D may be approximately equal. For example, the refractive index of the substrate 9 may be between 1.55 and 1.65. A material of the substrate 9 may include polycarbonate (PC), polymethyl methacrylate (PMMA) or other transparent high refractive index materials. For example, a thickness (a dimension in the second direction D2) of the substrate 9 may be between 0.05 and 0.2 mm.

In some embodiments, the second bonding adhesive 8 may include pressure sensitive adhesive (PSA) or optically transparent adhesive (OCA). The second bonding adhesive 8 may be a transparent adhesive layer. A refractive index of the second bonding adhesive 8 may be substantially equal to the refractive index of the light guide structure 2.

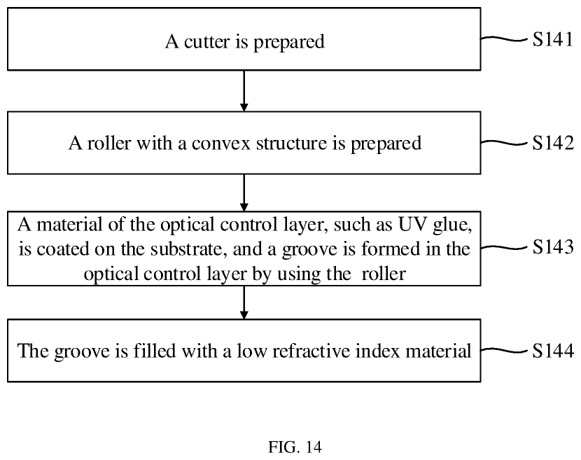

FIG. 14 is a flowchart of a method for manufacturing a light source module according to the embodiments of the present disclosure. With reference to FIGS. 1 to 14 in combination, the method for manufacturing the light source module includes steps of preparing the optical structure, for example, the steps of preparing the optical structure may be performed according to the following steps.

In step S141, a cutter is prepared. A shape of the cutter is the same as the shape of the optical structure to be formed. For example, a cross-section of the cutter may have a bending line shape similar to “W”.

In step S142, a roller with a convex structure is prepared. For example, the roller may be prepared using the above-mentioned cutter. A shape of the convex structure of the roller is the same as the shape of the optical structure to be formed. For example, a cross-section of the convex structure of the roller may have a bending line shape similar to “W”.

In step S143, a material of the optical control layer, such as UV glue, is coated on the substrate, and a groove is formed in the optical control layer by using the above-mentioned roller. A shape of the groove is the same as the shape of the optical structure to be formed. For example, a cross-section of the groove may have a bending line shape similar to “W”.

In some embodiments, the light guide structure may be used as a substrate, so that the substrate and the second bonding adhesive that bonds the light guide substrate and the substrate may be omitted, which saves costs and makes the light source module lighter and thinner.

In some embodiments, the steps of preparing the optical structure may include the following steps.

In step S144, the groove is filled with a low refractive index material, the refractive index of the low refractive index material is less than the refractive index of the optical control layer body, and the optical structure includes the groove and the low refractive index material in the groove.

In the embodiments of the present disclosure, each optical structure may be processed by using a same roller, which is beneficial to simplify the process and save the manufacturing cost. In addition, for various optical structures with different depths, only one roller is still needed, and by adjusting processing depths, optical structures with different depths may be formed.

Optionally, the embodiments of the present disclosure further provide a display device, and the display device may include the above-mentioned display module. The display device may include, but is not limited to: electronic paper, mobile phones, tablet computers, televisions, monitors, notebook computers, digital photo frames, navigators and other products or components with display functions. It should be understood that the display device has the same beneficial effects as the display module provided in the above-mentioned embodiments.

The above description is only specific implementations of the present disclosure, but the protection scope of the present disclosure is not limited thereto. Changes or substitutions easily conceived by those skilled in the art within the scope of the technology disclosed in the present disclosure should be covered by the protection scope of the present disclosure. Therefore, the protection scope of the present disclosure should be subject to the protection scope of the claims.

Although some embodiments of the general concept of the present disclosure have been illustrated and described, those ordinary skilled in the art will understand that changes can be made to these embodiments without departing from the principles and spirit of the general concept of the present disclosure. The scope of the present disclosure is defined by the claims and their equivalents.

1. A light source module, comprising:
a light source;
a light guide structure comprising a light incident surface and a first surface, wherein light emitted by the light source enters the light guide structure through the light incident surface;
an optical control layer arranged on the first surface of the light guide structure, wherein the optical control layer comprises an optical control layer body, a third surface away from the light guide structure, and a fourth surface facing the light guide structure; and
a plurality of optical structures arranged in the optical control layer, wherein the plurality of optical structures are configured to adjust the light incident on the plurality of optical structures,
wherein the plurality of optical structures are arranged at intervals at least in a first direction, and the first direction is perpendicular to the light incident surface,
wherein each of the plurality of optical structures comprises a groove in the optical control layer, and the groove forms an opening in the third surface,
wherein each of the plurality of optical structures comprises a first optical surface, a second optical surface, a third optical surface, and a fourth optical surface, and each of the first optical surface, the second optical surface, the third optical surface, and the fourth optical surface is spaced apart from the fourth surface, and the first optical surface, the second optical surface, the third optical surface, and the fourth optical surface are sequentially away from the light incident surface in the first direction,
wherein the first optical surface and the second optical surface gradually move closer in a direction toward the light guide structure, the second optical surface and the third optical surface gradually move closer in a direction away from the light guide structure, and the third optical surface and the fourth optical surface gradually move closer in a direction toward the light guide structure, and
wherein:
the groove is filled with a low refractive index material, and a refractive index of the low refractive index material is less than a refractive index of the optical control layer body; or
the groove is filled with air, the refractive index of the optical control layer body is greater than a refractive index of air.

2. The light source module according to claim 1, wherein the first optical surface and the second optical surface converge at a first intersection line, and the second optical surface and the third optical surface converge at a second intersection line, the third optical surface and the fourth optical surface converge at a third intersection line, and
wherein the first intersection line, the second intersection line, and the third intersection line are parallel to each other, and each of the first intersection line, the second intersection line and the third intersection line is parallel to the third surface, and each of the first intersection line, the second intersection line, and the third intersection line is located on a side of the third surface close to the fourth surface.

3. The light source module according to claim 2, wherein:
0°<α1, α2, α3, a4<90°,
H1>H3>H2>0, and
M3>M2>M1>0,
wherein α1 is an included angle between the first optical surface and a plane where the third surface is located, α2 is an included angle between the first optical surface and the second optical surface, and α3 is an included angle between the second optical surface and the third optical surface, and α4 is an included angle between the third optical surface and the fourth optical surface,
wherein H1 is a distance between the first intersection line and the plane where the third surface is located, H2 is a distance between the second intersection line and the plane where the third surface is located, and H3 is a distance between the third intersection line and the plane where the third surface is located,
wherein the first optical surface and the third surface converge at a fourth intersection line, the fourth optical surface and the third surface converge at a fifth intersection line, and
wherein M1 is a distance between the second intersection line and the fifth intersection line in the first direction, M2 is a distance between the first intersection line and the fifth intersection line in the first direction, and M3 is a distance between the fourth intersection line and the fifth intersection line.

4. The light source module according to claim 3, wherein each of the first intersection line, the second intersection line, the third intersection line, the fourth intersection line, and the fifth intersection line is perpendicular to the first direction.

5. The light source module according to claim 1, wherein a refractive index of the light guide structure is substantially equal to the refractive index of the optical control layer body.

6. The light source module according to claim 1, wherein the first optical surface is a curved surface that is recessed toward inside of each of the plurality of optical structures, and each of the second optical surface, the third optical surface and the fourth optical surface is a plane.

7. The light source module according to claim 1, wherein the light source module comprises at least a first distribution area and a second distribution area, and the first distribution area is closer to the light incident surface than the second distribution area in the first direction, and
wherein a depth of a first optical structure in the plurality of optical structures located in the first distribution area is less than a depth of a second optical structure in the plurality of optical structures located in the second distribution area, the depth being a dimension of a respective optical structure in a second direction, the second direction being perpendicular to the third surface.

8. The light source module according to claim 1, wherein the light source module comprises at least a first distribution area and a second distribution area, and the first distribution area is closer to the light incident surface than the second distribution area in the first direction, and
wherein a first pitch of first optical structures in the plurality of optical structures located in the first distribution area is greater than a first pitch of second optical structures in the plurality of optical structures located in the second distribution area, the first pitch being a distance between two adjacent optical structures in the first direction.

9. The light source module according to claim 1, wherein the plurality of optical structures are arranged at intervals at least in a third direction, and the third direction is parallel to the third surface and perpendicular to the first direction.

10. The light source module according to claim 9, wherein the light source module comprises at least a first distribution area and a second distribution area, and the first distribution area is closer to the light incident surface than the second distribution area in the first direction, and
wherein a second pitch of first optical structures in the plurality of optical structures located in the first distribution area is greater than a second pitch of second optical structures in the plurality of optical structures located in the second distribution area, and the second pitch being a distance between two adjacent optical structures in the third direction.

11. The light source module according to claim 1, further comprising:
a protection structure arranged on a side of the optical control layer away from the light guide structure; and
a first bonding adhesive arranged between the optical control layer and the protection structure,
wherein an orthographic projection of the first bonding adhesive on the first surface covers an orthographic projection of the plurality of optical structures on the first surface.

12. The light source module according to claim 11, wherein a refractive index of the protection structure, a refractive index of the first bonding adhesive, and the refractive index of the optical control layer body are substantially equal to each other.

13. The light source module according to claim 11, further comprising:
a second bonding adhesive and a substrate, arranged between the light guide structure and the optical control layer, wherein the second bonding adhesive, the substrate, and the optical control layer are arranged away from the light guide structure sequentially.

14. The light source module according to claim 13, wherein a refractive index of the second bonding adhesive, a refractive index of the substrate, and the refractive index of the optical control layer are substantially equal to each other.

15. The light source module according to claim 1, wherein the refractive index of the optical control layer body is between 1.55 and 1.65.

16. A display module comprising the light source module according to claim 1.

17. The display module according to claim 16, further comprising:
a display panel arranged on a side of the light guide structure away from the optical control layer, wherein the display panel is a reflective display panel, and a display surface of the display panel faces the light guiding structure.

18. A method for manufacturing a light source module, comprising:
preparing a roller with a convex structure, wherein a shape of the convex structure of the roller is the same as a shape of an optical structure to be formed; and
coating a material of an optical control layer on a substrate, and forming a groove in an optical control material layer by using the roller, so as to form the optical control layer comprising the optical structure, wherein a shape of the groove is the same as the shape of the optical structure to be formed,
wherein the optical control layer comprises an optical control layer body, and a refractive index of the optical control layer body is greater than a refractive index of air,
wherein the optical control layer comprises a third surface and a fourth surface, and the groove is formed in the third surface, and
wherein the optical structure comprises a first optical surface, a second optical surface, a third optical surface, and a fourth optical surface, and each of the first optical surface, the second optical surface, the third optical surface, and the fourth optical surface is spaced apart from the fourth surface, and the first optical surface, the second optical surface, the third optical surface, and the fourth optical surface are sequentially arranged in the first direction, and the first optical surface and the second optical surface gradually move closer toward the fourth surface, the second optical surface and the third optical surface gradually move closer toward the first surface, and the third optical surface and the fourth optical surface gradually move closer toward the fourth surface.

19. The method according to claim 18, further comprising:
filling the groove with a low refractive index material, wherein a refractive index of the low refractive index material is less than the refractive index of the optical control layer body, and the optical structure comprises the groove and the low refractive index material in the groove.
